(19) United States
(12) Patent Application Publication
(10) Pub. No.: US 2004/0112318 A1
(43) Pub. Date: Jun. 17, 2004

(54) Method for detecting the phase using $g(l)-change on one or more cylinders

(76) Inventor: Boerkel Wolfgang, Benningen (DE)

Correspondence Address: KENYON & KENYON, ONE BROADWAY, NEW YORK, NY, 10004, US

(21) Appl. No.: 10/473,854

(22) PCT Filed: Mar. 21, 2002
(86) PCT No.: PCT/DE02/01024

(30) Foreign Application Priority Data
Apr. 4, 2001 (DE) 101 16 815.2

(51) Int. Cl. F02P 9/00; G01M 15/00

(52) U.S. Cl. 123/179.5; 73/116

(57) ABSTRACT

A method of detecting the phase of a multicylinder spark-ignition internal combustion engine having an even or odd number of cylinders which is operated using an engine management system. The working cycle of the internal combustion engine extends over at least two revolutions. When the phase position is unknown, the internal combustion engine is started with double ignition output under the assumption of a phase position. An intervention in the formation of the mixture with respect to a leaning or enriching of the mixture is performed at one or more cylinders in the internal combustion engine. Based on the detection of and the changes in the air ratio λ, the phase position assumed at the beginning when the internal combustion engine was started is verified or falsified. When the assumed phase position is falsified, an emergency operation of the internal combustion engine with double ignition output is maintained, newly synchronized, or resynchronized.

### TECHNICAL AREA

To determine the position of the crankshaft angle in multicylinder multiengines, sensors are used which continuously scan a sensor wheel which is non-rotatably connected to the crankshaft. Ring gears having an irregularity at one location which is associated with the top dead center (TDC) of one of the engine pistons are usually used for this purpose. However, for rotational angles associated with ignition or injection processes, the sensor generates an unambiguous signal only when such a process has to be actuated each time a rotational angle is reached. For four-stroke internal combustion engines, however, the working cycle extends over a crankshaft angle of 720°, resulting in two signals which are associated with the top dead center (TDC).

### BACKGROUND INFORMATION

German Patent Application 41 22 786 A1 relates to a method of identifying the rotational angle associated with an ignition or injection process of an internal combustion engine. The working cycle of the internal combustion engine extends over at least two revolutions of its output shaft. Ignition or injection processes are initiated, as the result of which an actual reaction of the engine to these ignition or injection processes is determined and compared to a setpoint reaction to the ignition and injection processes, also at the associated rotational angle.

European Patent 826 099 B1 relates to a method of detecting the phase position of the cylinders of a multicylinder four-stroke internal combustion engine. According to this approach, a multicylinder combustion engine is provided with an ignition system for individually controlling each cylinder, and includes a sensor for generating a signal which allows the passage of the piston in a reference cylinder in the combustion engine to be identified in a specified position. According to the method proposed in European Patent 826 099 B1, runs through a cycle having multiple steps, and firstly for the reference cylinder, at a specified instantaneous moment which is associated with the passage of the piston in the reference cylinder in the predetermined position, an interference is actuated so that a variation in the operating mode of the engine is produced. The operating mode of the engine is then observed, and a possible variation of the operating mode resulting from the control of the interference in the reference cylinder is detected, and the instantaneous moment when the variation in the engine's operating mode suddenly appears, or when a variation in the engine's operating mode fails to appear, is determined. Subsequently, the specified instantaneous moment when the interference is controlled is compared to the detected instantaneous moment when the variation in the operating mode of the engine suddenly appears, or when a variation in the operating mode of the engine fails to appear, in order to deduce the phase of the engine cycle in which the reference cylinder is situated in the specified position. Finally, based on the knowledge of the phase of the reference cylinder, the phase of a cylinder in the internal combustion engine is identified. Using the approach proposed in European Patent 826 099 B1, the interference is controlled by the fact that a modification of the ignition energy compared to a normal operating mode is controlled which is different from that resulting from a complete interruption of the ignition control, and the detection of the resulting possible variations in the operating mode of the engine lies in the fact that a possible variation in the torque is detected at an instantaneous moment when the variation in torque suddenly appears.

U.S. Pat. No. 5,425,340 relates to a method of marking cylinders for controlling an electronic injection system for an internal combustion engine which can be used for a sequential multipoint injection system. The crankshaft of the internal combustion engine is associated with a crankshaft sensor which detects the passage of the top dead centers of each of the cylinders, thus enabling combustion misfires to be detected. First, injection of fuel into a selected reference cylinder is stopped. The occurrence of a misfire at this selected reference cylinder is then detected. The moment when the fuel injection into the selected reference cylinder is interrupted is then compared to the moment when a misfire occurs in the selected reference cylinder. In addition, the passage of the TDC during the intake/compression stroke in the selected reference cylinder is detected. A signal sequence is then formed which represents the cylinders in the internal combustion engine which are in phase with the TDC signal. This signal sequence is generated at the moment when the intake/compression stroke TDC is detected and the combustion sequence corresponding to the ignition sequence of the internal combustion engine is resumed.

In addition to the approaches outlined above, when the phase sensor fails it is possible to easily perform emergency running functions by switching to redundant sensors, or sensors on another cylinder bank of the internal combustion engine (V engines). Furthermore, it is possible to use a phase position recorded when the internal combustion engine was shut off.

### DESCRIPTION AND ADVANTAGES OF THE INVENTION

The advantages of the approach proposed by the present invention are primarily that, using the method proposed by the present invention, it is possible to perform phase detection for an internal combustion engine without providing a phase sensor, or when the phase sensor fails for emergency running of the internal combustion engine.

When the phase position of the cylinders in a multicylinder internal combustion engine is unknown, a phase position is assumed. The assumed phase position may be, for example, the phase position of the crankshaft of the internal combustion engine taken up when the engine was shut off. At this point the internal combustion engine is started with double ignition output in the ignition and charge exchange TDC. Based on the assumed phase position in the internal combustion engine, an enriching or leaning is now performed by an appropriate intervention in the formation of a mixture composed of fuel and intake air in one or more cylinders in the internal combustion engine. The enriching or leaning of the mixture in the selected cylinders is carried out in each case only to the extent needed to prevent misfires, and is limited to a specifiable period of time. During the intervention in the formation of the mixture in the selected cylinder or in the selected cylinders, it is possible to maintain the summed λ at the intended value by appropriate interventions, so that the internal combustion engine emits exhaust substantially at the optimal level.

The enriching or leaning of the mixture in the selected cylinder or in the selected cylinders in the internal combustion engine represents merely a short-term, hardly noticeable forfeiture of comfort, which is considerably less than that resulting from an exclusion of fuel injection at one of the cylinders in the internal combustion engine. The intervention in the formation of the mixture is performed in suitable engine operating ranges in which an optimal detection is possible. In these engine operating ranges the forfeiture of driving comfort remains within limits. Suitable engine operating ranges for interventions in the formation of the mixture at one or more selected cylinders in the internal combustion engine are those in which the rotational speed of the internal combustion engine remains largely constant and no pronounced acceleration phases occur, i.e., in a partial load region of the internal combustion engine.

In the evaluation of the λ differences, a continuous λ probe and appropriate evaluation algorithms in the engine control unit may be used, such as those finding application for single-cylinder λ regulation. The intervention in the formation of the mixture for one or more selected cylinders results in an uneven distribution in the mixture which may cause a possible, although minimal, degradation of the exhaust gas, since it is possible to maintain the summed λ at the optimal level over all cylinders.

For a vehicle in whose internal combustion engine the phase position is identified using the method proposed by the present invention, the influences on ride comfort are hardly noticeable. An additional advantage of the method proposed by the present invention is the fact that, in addition to minimal forfeiture of ride comfort, the method may be used in internal combustion engines, whether they are V engines or inline engines having an even or odd number of cylinders.

### DETAILED DESCRIPTION OF THE EMBODIMENT VARIANTS

In engine management systems for modern multicylinder internal combustion engines, phase sensor defects are identified immediately so that remedy routines according to the method proposed by the present invention may be used. If there is no redundancy in the internal combustion engine, perhaps as the result of an additional functioning phase sensor, the internal combustion engine is started using an assumed phase position. This assumed phase position may, for example, correspond to the phase position which has occurred when the internal combustion engine is shut off. Using this permanently stored information present in the engine management system, it is possible to start a multicylinder internal combustion engine. For four-stroke internal combustion engines, for example, whether for 4-, 6-, or 8-cylinder engines, there is an ignition output in TDC after the compression stroke and after the exhaust stroke, resulting in a double ignition output. The phase position of the internal combustion engine assumed at the beginning is not checked until the internal combustion engine has reached a suitable operating range with respect to constant load, constant rotational speed, and attainment of the engine operating temperature. This may occur after the internal combustion engine has operated for some time in idle mode, or may be an approximately stationary operating phase of the internal combustion engine. In addition, the λ regulation must be operative.

After the internal combustion engine has reached an operating range that appears to be suitable according to the method proposed by the present invention, an intervention in the formation of the mixture at one or more selected reference cylinders is performed in the direction of enriching the mixture or leaning the mixture. The summed X regulation remains in operation at one or more selected reference cylinders for this intervention in the formation of the mixture. In engine management systems for internal combustion engines, the selected cylinder(s) at which an intervention in the formation of the mixture is performed with respect to an enriching or a leaning is known.

After the intervention in the formation of the mixture is performed in one or more selected cylinders in the internal combustion engine, testing is carried out to determine how air ratio λ at the correspondingly selected cylinders(s) has changed. If air ratio λ at the affected selected cylinder has varied to a significant detectable degree in the expected direction with respect to a leaning or an enriching of the mixture, the initially assumed phase position of the internal combustion engine is in agreement. When this result is obtained, the engine may be switched to normal operation; i.e., when the top dead center for the exhaust stroke is reached, the ignition process may thus be cancelled. In addition, angle synchronous events such as injection processes, for example, may be enabled when the phase position is detected to be correct. The phase detection may subsequently be shut off completely.

On the other hand, if no enriching or leaning occurs in the selected cylinder or in the selected cylinders, i.e., the λ value remains constant, the phase position assumed when the internal combustion engine was started was false. In addition, as the result of a falsely assumed phase position for starting the internal combustion engine, conclusions may be drawn as to whether a small change in air ratio λ in the opposite direction for the selected cylinder or for the selected cylinders will occur as a result of the compensation.

This is the case when the summed λ is regulated to the value which air ratio λ has assumed before the intervention in the formation of the mixture in the selected cylinder or in the selected cylinders.

If the internal combustion engine is a multicylinder internal combustion engine having an even number of cylinders, or an even number of cylinders per bank for V engines, air ratio λ of the cylinder offset by a crank angle of 360° with respect to the selected cylinder may also be evaluated. If this cylinder offset by a crank angle of 360° with respect to the selected reference cylinder shows the λ change produced, the phase position assumed when the internal combustion engine was started was false. Although the use of the cylinder offset by a crank angle of 360° with respect to the selected cylinder for detecting changes in λ is described only for internal combustion engines having an even number of cylinders or an even number of cylinders per bank of V engines, most of the customary four-stroke internal combustion engines have an even number of cylinders. The advantage of using the method proposed by the present invention for internal combustion engines having an even number of cylinders is the fact that, when air ratio λ for only one cylinder is manipulated, this manipulation for the same summed λ is more prominent than the reaction of the other cylinders, due to the compensation for the error in summed air ratio λ caused by the intervention in one cylinder.

Whereas the phase detection may be shut off when the assumed phase position and the detected phase position match, when a false phase position is detected it is necessary for the internal combustion engine to be resynchronized or newly synchronized. In addition, emergency operation with double ignition output may be maintained at the end of the compression stroke and at the end of the exhaust stroke. If the internal combustion engine is resynchronized or newly synchronized, the accuracy of this synchronization should then be checked once more before the double ignition output is shut off.

On the other hand, if the phase detection has not resulted in an unambiguous result, for example as the result of an unstable operating state of the internal combustion engine or other external influences, the test procedure may be repeated as often as desired, for example after a presettable timer has lapsed, as soon as a suitable driving situation for carrying out the test procedure, i.e., a suitable partial load region of the internal combustion engine, has been reached. For the timer, which may be accommodated in the engine management system for the internal combustion engine, the time after the timer's lapse at which the phase detection may be redetermined according to the method proposed by the present invention may be freely selected in advance; i.e., the intervals between the individual detection processes for determining the phase position of the internal combustion engine are flexible and adjustable.

If a new phase detection is performed for the internal combustion engine when a previous detection of the phase position has failed, this new phase detection may be carried out on the cylinders in the internal combustion engine which have been previously selected, as well as on newly selected cylinders. The method proposed by the present invention may be carried out on the cylinders in the internal combustion engine until it is possible to make an unambiguous statement about the phase position of the internal combustion engine.

Since the determination of changes in the air ratio by intervention in the formation of the mixture, whether by enriching or leaning, at one selected cylinder or at selected cylinders in the internal combustion engine, is based on the method proposed by the present invention instead of an exclusion of the fuel injection, it is possible to operate the internal combustion engine with an essentially normal exhaust gas response with respect to the summed λ value. In contrast to an exclusion of injection, the resulting forfeitures of driving comfort are maintained within narrow limits. The method proposed by the present invention for detecting the phase in a multicylinder internal combustion engine with the phase sensor omitted maybe used in internal combustion engines having an even or odd number of cylinders, and allows reliable phase detection since the occurrence of multiple events is observed. Thus, the reliability of the statement obtained regarding the phase position is very high, and a breakdown of the vehicle on account of a failed phase sensor is prevented.

What is claimed is:

1. A method of detecting the phase of a multicylinder spark-ignition internal combustion engine having an even or odd number of cylinders which is operated using an engine management system, the working cycle of the internal combustion engine extending over at least two revolutions of its output shaft, and the internal combustion engine being started under the assumption of a phase position when the phase position is unknown, having the following steps:
when the phase position is unknown, the internal combustion engine is started under the assumption of a phase position;
an intervention in the formation of the mixture with respect to a leaning or enriching of the mixture is performed at one or more selected cylinders in the internal combustion engine;
based on the detection of the air ratio λ in the individual cylinders, the phase position assumed at the beginning is verified or falsified, and when the exhaust gas associated with the selected cylinder or the selected cylinders shows no change in the air ratio λ corresponding to the intervention in the formation of the mixture in the selected cylinder, a falsification is determined; or
when the exhaust gas associated with the selected cylinder or the selected cylinders shows a change in the air ratio λ in the direction opposite to the intervention in the formation of the mixture at the selected cylinder or the selected cylinders as a result of compensation for the regulation of the summed λ value to the λ value before the intervention in the formation of the mixture, a falsification is determined; or
when the exhaust gas associated with the cylinders which are offset by an angle of 360° with respect to the selected cylinder shows a change in the air ratio λ corresponding to the intervention in the formation of the mixture, a falsification is determined; and
when the assumed phase position is falsified, engine operation with double ignition output is maintained.

2. The method as recited in claim 1,
wherein the internal combustion engine is started with double ignition output at the end of the compression stroke and at the end of the exhaust stroke under the assumption of a phase position.

3. The method as recited in claim 1,
wherein the phase of the internal combustion engine is detected in a suitable operating range of the internal combustion engine with respect to load, rotational speed, or temperature, and operability of a λ probe.

4. The method as recited in claim 1,
wherein the phase position of the internal combustion engine assumed at the beginning is verified when a change in the air ratio λ corresponding to the intervention in the formation of the mixture at the selected cylinder is detected.

5. The method as recited in claim 4,
wherein when the phase position of the internal combustion engine is verified, the double ignition output is cancelled and angle-synchronous events are enabled.

6. The method as recited in claim 1,
wherein when the phase position is falsified, the phase position of the internal combustion engine is newly synchronized or resynchronized.

7. The method as recited in claim 1,
wherein when the detection of the phase position of the internal combustion engine has failed, the phase detection is repeated at the same or newly selected cylinders in the internal combustion engine after a predeterminable time or a predeterminable number of working cycles (revolutions) has elapsed.
